(19) United States
(12) Patent Application Publication
(10) Pub. No.: US 2007/0230597 A1
(43) Pub. Date: Oct. 4, 2007

(54) DYNAMIC OPTIMISATION OF BLOCK TRANSMISSIONS FOR INTERFERENCE AVOIDANCE

(75) Inventor: Justin COON, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/534,831

(22) Filed: Sep. 25, 2006

(30) Foreign Application Priority Data
Apr. 3, 2006 (GB) 0606687.2

(51) Int. Cl. H04K 1/10

(52) U.S. Cl. 375/260

(57) ABSTRACT

Spectral shaping for narrowband interference avoidance is an important part in cognitive radio, and is essential in ultra wideband (UWB) communication systems. Typically, interference occurs when a broadband user's signal collides with a narrowband user's signal, thus resulting in degradation in performance for the two communication links. It has been proposed that, in some applications, the broadband user should modify his signal such that little or no energy is transmitted on the frequencies on which the narrowband user's signal resides. This ‘interference avoidance’ (IA) technique provides some separation of users' signals such that, with the possible aid of signal processing, both communication links do not significantly suffer from multi-user interference.

The proposed invention provides a means of implementing interference avoidance in a dynamic manner for a modest increase in complexity at the transmitter. Furthermore, in some scenarios, the receiver does not need any additional information about the transmitted signal in order to recover the transmitted message. The proposed invention overcomes some of the drawbacks of current techniques such as transmit power control (TPC), frequency notching, and active interference avoidance (AIC) and can be implemented in both single-carrier and multi-carrier systems when the packet length is fixed.

The present invention relates to a method of spectral shaping of a signal. More particularly it relates to a method of spectral shaping which may be used for interference avoidance in a dynamic manner, and the corresponding signal transmission system and receiver.

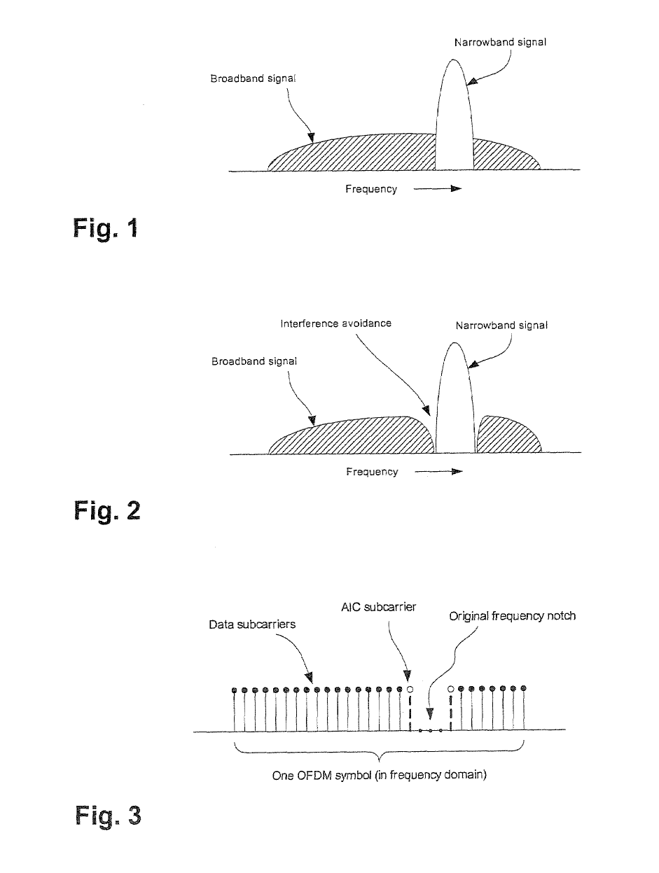

Spectral shaping for narrowband interference avoidance is an important part in cognitive radio, and is essential in ultra wideband (UWB) communication systems. With reference to FIG. 1, which illustrates an example of a narrowband and a broadband signal occupying overlapping bandwidth in the frequency domain, the problem typically occurs when a broadband user's signal collides with a narrowband user's signal in the frequency spectrum, thus resulting in degradation in performance for the two communication links.

It has been proposed that, in some applications, the broadband user should modify his signal such that little or no energy is transmitted on the frequencies on which the narrowband user's signal resides. FIG. 2 illustrates this ‘interference avoidance’ (IA) technique in an example of a narrowband and a broadband signal, where interference avoidance provides some separation of users' signals in the frequency domain such that, with the possible aid of signal processing, both communication links do not significantly suffer from multi-user interference.

Interference avoidance is especially important in UWB communications, since UWB systems utilise a very broad bandwidth for low-power transmission, which makes interference with narrowband users virtually unavoidable. This problem is exacerbated by the fact that UWB devices are unlicensed (i.e. operators do not pay for licences), whereas the devices with which they interfere are licensed. Obviously, priority should be given to licensed users in these scenarios; in this case, interference avoidance should be applied at the transmitter of the UWB device.

Some work has been carried out on the subject of interference avoidance. Common methods of implementing interference avoidance include transmit power control, frequency notching, and active interference cancellation.

Transmit power control (TPC) is based on the principle of transmitting data using the minimum amount of power that is required. Of course, the drawback of this technique is that the device that implements TPC attenuates its entire signal, which may lead to catastrophic performance in extreme cases (i.e. little or no information is conveyed).

Frequency notching involves nulling a transmitted signal on localised portions of bandwidth. Frequency notching can be achieved through simple analogue notch filters, although it is difficult and usually impractical to design tuneable notch filters for dynamically creating nulls (notches) with varying widths and centre frequencies. Dynamic frequency notching may arise in many scenarios, such as when a broadband device shares its bandwidth with a slow-frequency-hopping spread-spectrum transmission. A more practical solution to dynamic frequency notching can be realised in block transmission systems, such as cyclic-prefixed single-carrier and OFDM systems, through the use of a fast Fourier transform (FFT). In particular, frequency notches can be dynamically designed by inserting zeroes at the appropriate pins in the (inverse) FFT. Unfortunately, the depths of the frequency notches in practice are somewhat limited due to the upsampling of the signal. Consequently, even if a discrete, symbol-spaced signal is designed to have perfect (infinitely deep) frequency notches, once this signal is upsampled, these notches can be as shallow as only −9 dB.

An active interference cancellation (AIC) technique for multi-band OFDM cognitive radio has been proposed by H. Yamaguchi in: “Active interference cancellation technique for MB-OFDM cognitive radio,” 34th European Microwave Conference, vol. 2, 2004, incorporated herein by reference.

Active interference cancellation is a form of frequency notching used in OFDM systems whereby additional frequency tones are allocated at either side of the original notch for interference cancellation. FIG. 3 depicts an example of the distribution of data subcarriers for one OFDM symbol in the frequency domain. In addition to the nulled subcarriers creating the original frequency notch, the two neighbouring AIC subcarriers are likewise modified. In this context, the term ‘interference cancellation’ refers to the nulling of any additional signal energy that resides in the desired frequency notch when the signal is upsampled. This technique can achieve deeper notches in the transmit spectrum than conventional frequency notching for both single-carrier and multi-carrier block transmission systems. However, AIC suffers from two major drawbacks:

1. Like frequency notching, data must be nulled, or punctured, in order to avoid interfering with narrowband signals. In variable-length transmissions, this issue is not a large problem, although it does mean that any nulled data must be transmitted using additional channel resources. If additional OFDM symbols are required to transmit the punctured data, the data rate may be considerably reduced. In fixed-length transmissions, however, this drawback is crucial since any punctured data is lost. In this case, the performance of a system degrades even for narrow frequency notches.

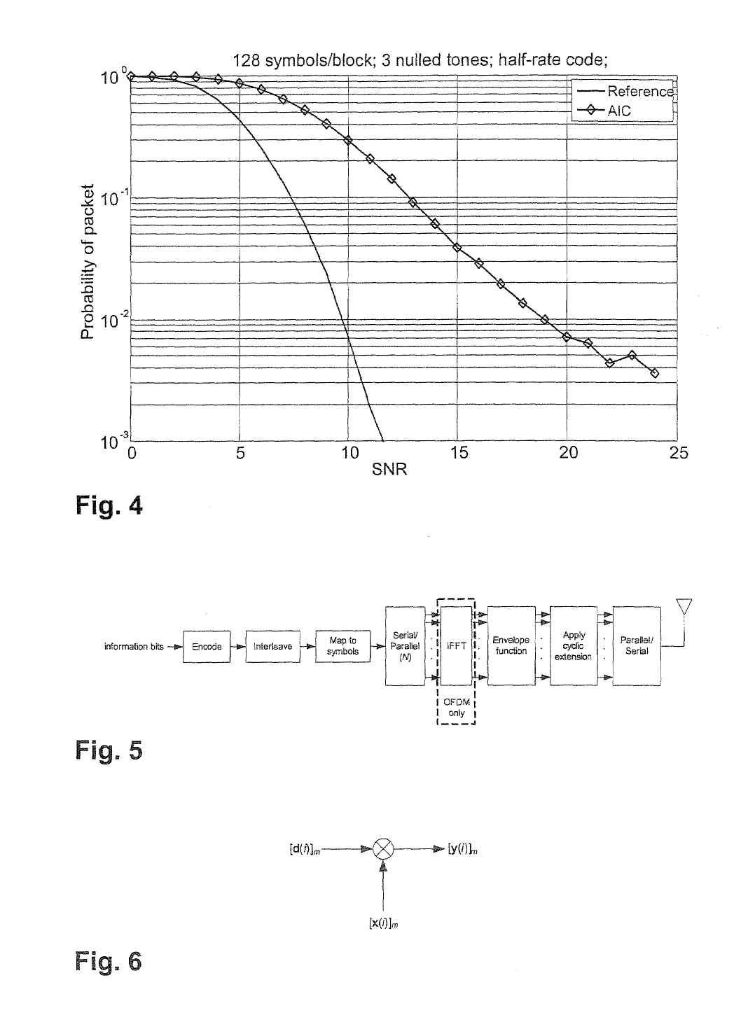

2. Since AIC is implemented in the frequency domain, it is not able to be effectively adapted to single-carrier systems. In fact, the perturbation of the frequency-domain signal in a single-carrier system leads to very poor performance, even with a strong error correction code (ECC) and robust modulation. This is shown in FIG. 4, which depicts the probability of packet error versus the signal-to-noise ratio (SNR) for 128 symbols per block with three nulled tones and a half-rate convolutional code.

Narrowband interference avoidance in ultra wideband communication systems has been discussed by P. Yaddanapudi and D. Popescu in: “Narrowband interference avoidance in ultra wideband communication systems,” IEEE Global Telecommunications Conference (GLOBECOM), 2005, incorporated herein by reference.

In US 2005/0232336 A1 (Balakrishnan et al.), incorporated herein by reference, a system for signal shaping in ultra-wideband communications by spectral shaping in the frequency domain is disclosed.

The systems described above have a number of drawbacks and inconveniences. Systems that implement TPC to perform interference avoidance cannot, by definition, transmit at full power; thus a loss in information rate is unavoidable. Conventional frequency notching can realistically provide notches on the order of approximately only -9 dB. Finally, while active interference cancellation works well in multi-carrier systems with a variable transmission length, when applied to fixed transmission length systems and (especially) single-carrier systems, the performance of a system using this technique degrades significantly.

The present invention proposes a method of achieving spectral shaping, and in particular interference avoidance, in a dynamic manner without incurring the drawbacks stated above. The proposed invention provides a means of implementing interference avoidance in a dynamic manner for a modest increase in complexity at the transmitter. Furthermore, in some embodiments, the receiver does not need any additional information about the transmitted signal in order to recover the transmitted message.

The present invention consists of applying an optimised envelope fluctuation to each block in a block transmission (such as a cyclic-prefixed single-carrier transmission) in order to facilitate spectral shaping for interference avoidance in a dynamic manner.

Moreover, the present invention is suitable for application in any wireless or wired communication devices that use block transmissions (e.g. cyclic-prefixed single-carrier transmissions, OFDM) where interference avoidance is desired. Example devices in the current market include UWB-equipped PDAs, cameras, laptops, etc.

In a first aspect of the present invention a method of shaping the spectrum of a signal in a block transmission system by applying a time-domain envelope function comprises the steps of optimising the time-domain envelope function under one or more constraints selected from a set of predetermined constraints and applying the optimised time-domain envelope function to the signal.

In one configuration of the above aspect the optimised time-domain envelope function is applied in a dynamic manner.

In another configuration of the above aspect the time-domain envelope function is optimised in a dynamic manner.

In a further configuration of the above aspect the update frequency of the dynamic manner relates to each symbol transmission.

In another configuration of the above aspect the set of constraints comprises signal transmission characteristics chosen in order to establish interference avoidance, power, a cost function, and/or a utility function.

In a further configuration of the above aspect the signal transmission system is a single-carrier, a multi-carrier, or an OFDM block transmission system.

In yet another configuration of the above aspect the envelope function is applied to all time-domain samples in a data block.

In a further configuration of the above aspect the envelope function is applied to all time-domain samples in a subset of a data block.

In another configuration of the above aspect the criterion selected is interference avoidance, e.g. for UWB systems.

In yet a further configuration the predetermined constraints comprise signal transmission characteristics, selected from among the group comprising peak-to-average power ratio (PAPR), total power, and dynamic range.

In another configuration of the above aspect the dynamic optimisation of the envelope function is performed numerically in an iterative manner.

In a further configuration of the above aspect the numerical optimisation technique is selected from the group comprising a gradient method, a steepest descent method, Newton's method, the barrier method, or the primal-dual method.

In yet another configuration of the above aspect the envelope function is constrained to be real-valued and positive so as to facilitate blind detection at the receiver.

In a further configuration of the above aspect the constellation of the data signal is constrained to be constant modulus so as to facilitate blind detection at the receiver.

In another configuration of the above aspect the parameters of the numerical optimisation technique, such as the stopping criteria, can be tuned (e.g. to improve convergence and/or to aid hardware implementation).

In another aspect of the present invention a computer program comprises data processing device program code means adapted to perform the method of the first aspect of the present invention when said program is run on a data processing device.

In another aspect of the present invention a computer-readable medium comprises computer-executable instructions to configure a signal transmission system to operate in accordance with the method according to the first aspect of the present invention.

In a further aspect of the present invention a spectrum-shaped signal is generated by the method according to the first aspect of the present invention.

In another aspect of the invention a signal transmission system comprises means for operating in accordance with the first aspect of the invention.

In yet a further aspect of the present invention a receiver comprises means for receiving a spectrum-shaped signal in accordance with the first aspect of the present invention.

These and other aspects of the invention will now be further described, by way of example only, with reference to the accompanying figures in which:

FIG. 1 illustrates an example of a narrowband and a broadband signal occupying overlapping bandwidth in the frequency domain.

FIG. 2 illustrates an example of narrowband interference avoidance in the frequency domain.

FIG. 3 illustrates the distribution of AIC subcarriers and OFDM symbol structure in the frequency domain.

FIG. 4 shows the performance of a cyclic-prefixed single-carrier system using AIC.

FIG. 5 shows a block diagram of a baseband transmitter structure according to the invention.

FIG. 6 illustrates the envelope function processing.

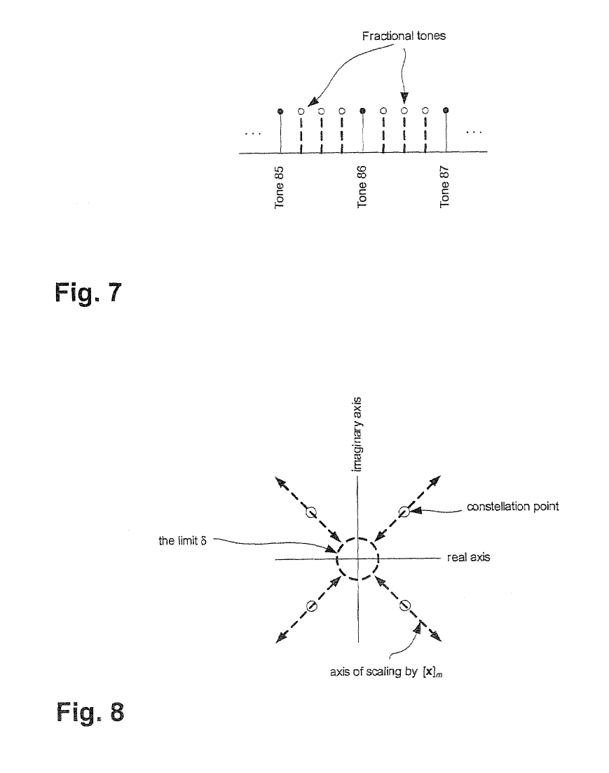

FIG. 7 illustrates an example of the fractional tones in dynamically optimised interference avoidance.

FIG. 8 illustrates an example of envelope scaling for a constant modulus constellation (QPSK).

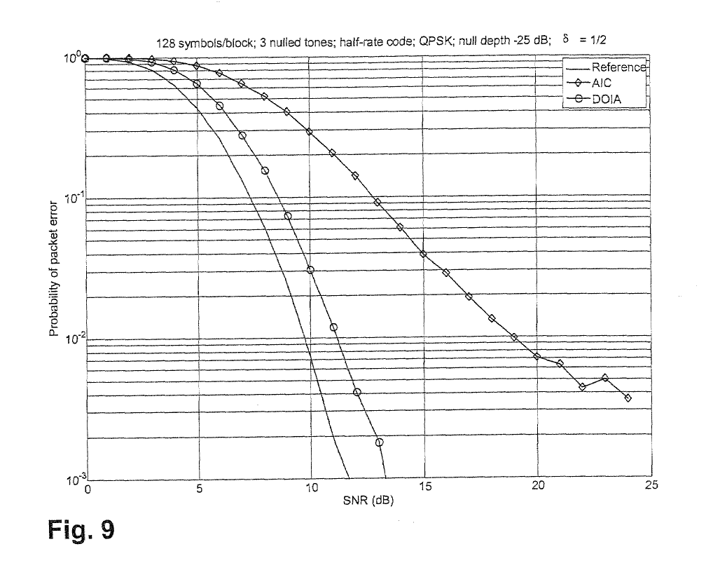

FIG. 9 shows the packet error rate vs. SNR for three single-carrier block transmission systems: a reference system; one employing AIC; and one employing the proposed dynamically optimised interference avoidance invention.

A method of shaping the spectrum of a signal in a block transmission system by applying a time-domain envelope function is disclosed. In the following description, a number of specific details are presented in order to provide a thorough understanding of embodiments of the present invention. It will be apparent, however, to a person skilled in the art that these specific details need not be employed to practice the present invention.

The process of applying an envelope to a transmitted signal in the time-domain for spectral shaping can be implemented in the analogue domain or the digital domain. The optimisation process detailed below is performed in the digital domain; however, it will be understood that similar analogue-domain techniques may be applied with a similar outcome.

The basic processing that is required at the transmitter is depicted in FIG. 5. In this figure, it is observed that a stream of bits is (optionally) encoded, interleaved, and mapped to complex baseband constellation symbols such as M-PSK or M-QAM where M is the size of the alphabet. The resulting constellation symbols are partitioned into blocks of length N. If this is a multi-carrier system such as OFDM, each block is then processed with an N-point inverse FFT (IFFT). Otherwise, if the system utilises conventional single-carrier modulation, no IFFT is performed. Finally, each block of time-domain data symbols is perturbed with an envelope function prior to further processing and/or transmission.

It is convenient to begin with a discussion of the envelope function that will be used for shaping the spectrum of the signal in the time-domain. The ith original block of data symbols (prior to the application of the envelope function) is denoted by the length-N column vector d(i). The processing that is performed by the envelope function is a simple scaling of each element of d(i) by a (possibly) complex-valued coefficient. This process is depicted in FIG. 6 where [a]ₘ denotes the mth element of the vector a, x(i) is the ith length-N column vector of envelope coefficients, and y(i) is the ith length-N column vector of symbols at the output of the envelope function. The key is to design the vector x(i) such that some spectral shaping criterion (or criteria) is satisfied. This design can be performed by formulating a cost (or utility) function f₀(x(i)) that is to be minimised (maximised).

minimise/maximise f₀(x(i))

subject to some constraints

In the case of interference avoidance, this cost function should logically define the amount of energy that is transmitted on a given set of frequencies, where the objective is to minimise this energy.

A key point that should be considered is that this energy should be defined for a set of frequencies after upsampling so as to avoid the problems that are encountered with simple frequency notching. A typical upsampling frequency might be four times the symbol-spaced sampling frequency, although any suitable faster or slower sampling rate may be used.

The general dynamic interference avoidance problem can be formulated mathematically. Accordingly, x(i) can be designed for dynamic interference avoidance as follows. Omitting the block index i without loss of generality, let D=diag {d}, and let WεC^{Q×N} (where C denotes the set of complex numbers) be the Q rows of the uN×N upsampled discrete Fourier transform matrix where u is the upsampling factor (e.g. u=4). For example, if it were desired that tones 85, 86, and 87 were to be nulled using an upsampling factor of u=4, then W would be a 9-by-N matrix since there are three fractional samples between 85 and 86, and there are three more fractional samples between 86 and 87 (FIG. 7). The minimisation problem can now be formulated as

minimise f₀(x)=∥WDx∥₂²

subject to some constraints

where ∥•∥₂ denotes the l₂-norm.

In order to solve the problem it may be necessary to add constraints to be observed when optimising. Depending on the nature of the constraints, this problem can be solved analytically or numerically. If a constraint were placed on the total power of the signal at the output of the envelope function, the problem could be formulated as

minimise f₀(x)=∥WDx∥₂²

subject to ∥Dx∥₂²=∥x∥₂²=N

[x]ₘ≧δ, ∀m

which can be solved analytically for the case where the envelope vector x is real-valued or complex-valued. In both cases, the optimal x simply lies in the null space of WD (and is normalised such that the constraint is true). As long as Q<N (i.e. W is a ‘fat’ matrix), the null space of WD will be non-empty. Otherwise, if Q≧N, the null space of WD is empty and x will not perfectly remove the energy from the interference tones, but it will minimise this energy as long as it is chosen to be the eigenvector corresponding to the smallest eigenvalue of the generalised eigenvalue problem:

D^{H}W^{H}WDx=λD^{H}Dx (complex-valued x)

[symbol]

e{D^{H}W^{H}WD}x=λD^{H}Dx (real-valued x)

Unfortunately, this solution requires that the receiver know what x was defined as during transmission. Of course, this information can be conveyed to the receiver by computing x(i+1) and including this information in y(i)=D(i) x(i). Obviously, this approach requires a high amount of overhead and buffering of data (at either the transmitter or the receiver) so that the receiver can recover the vector x(i) in order to be able to detect d(i). For this reason, this technique may in some cases be undesirable for some applications.

In practical situations, the receiver may not have knowledge of x. An additional constraint can therefore be added to the original interference avoidance problem, which allows the receiver to perform detection and decoding without having knowledge of x. In particular, the elements of x can be constrained to be real-valued and greater than or equal to some positive number δ. Furthermore, as shown in FIG. 8, if the constellation scheme is limited to being a member of the set of constant-modulus constellations (e.g. BPSK, QPSK, 8-PSK), a simple positive scaling of each data symbol would allow the receiver to distinguish between constellation points without knowledge of x. Under these constraints, the problem can be formulated as

minimise f₀(x)=∥WDx∥₂²

subject to ∥Dx∥₂²=∥x∥₂²=N

[x]ₘ≧δ, ∀m

In this case, the problem cannot in general be solved analytically. However, numerical nonlinear optimisation methods can be employed. These techniques include gradient descent methods, the method of steepest descent, Newton's method, and interior point methods (including the barrier method and the primal dual method). In particular, interior point methods excel when inequality constraints are present in the optimisation problem.

The interior point method known as the barrier method is particularly suited to the constrained minimisation problem stated above. The barrier method is summarized in Table 1:

```
given strictly feasible x, t > 0, μ > 1, εₒ > 0, εᵢ > 0
repeat
    1. Newton's method (x, εᵢ > 0)
        a. Δx = −∇²f (x)⁻¹∇f (x)
          λ² = −∇f (x)^{H} Δx
        b. quit if λ²/2 < εᵢ
          return x* := x
        c. line search (determine β)
        d. x := x + βΔx
    2. x := x*
    3. quit if p/t < ε₀
    4. t := μt
```

Table 1: Summary of the barrier method (Boyd, S. and Vandenberghe, L., Convex Optimization, Cambridge University Press. 2004).

(The parameters outlined in this table will be discussed in more detail below.) In order to implement the barrier method to solve the aforementioned optimisation problem, the quadratic equality constraint must be eliminated in some way. This requirement is a fundamental issue with the barrier method, which does not support nonlinear equality constraints. One simple method of eliminating the equality constraint is to add a small tolerance ε>0 to the norm constraint and replace the equality with a box inequality, which results in the modified but similar problem given by

minimise f₀(x)=∥WDx∥₂²

subject to N−ε≦∥x∥₂²≦N+ε

[x]ₘ≧δ, ∀m

The constraints of this problem are rewritten in a standard form, thus giving

minimise f₀(x)=∥WDx∥₂²

subject to f₁(x)=N−ε−∥x∥₂²≦0

f₂(x)=∥x∥₂²−N−ε≦0

fₘ₋₂(x)=δ−[x]ₘ≦0, ∀m

In the barrier method, inequality constraints are added to the cost (or utility) function by defining a logarithmic barrier constraint function for each inequality constraint. In this case, there are p=N+2 logarithmic barrier constraints, given by

$${g}_{1} ( x ) = - \frac{1}{t} log ( - {f}_{1} ( x ) ) = - \frac{1}{t} log ( {‖ x ‖}_{2}^{2} - N + ɛ )$$

$${g}_{2} ( x ) = - \frac{1}{t} log ( - {f}_{2} ( x ) ) = - \frac{1}{t} log ( N + ɛ - {‖ x ‖}_{2}^{2} )$$

$${g}_{m + 2} ( x ) = - \frac{1}{t} log ( - {f}_{m + 2} ( x ) ) = - \frac{1}{t} log ( {e}_{m}^{T} x - δ )$$

where eₘ^{T} is the mth length-N unit vector and the parameter t is the logarithmic barrier accuracy parameter, which is incremented with each outer iteration of the barrier method as outlined in Table 1. The purpose of the logarithmic constraint functions is to quantify the ‘displeasure’ of not satisfying the former inequality constraints. As the arguments of the logarithmic constraint functions approach zero (from below), the values of the functions approach infinity. Thus, these logarithmic constraint functions can be incorporated into the cost function to give a composite cost function. The new composite cost function is given by

$$f ( x ) = {tf}_{0} ( x ) + t \sum {g}_{k} ( x ) = {tf}_{0} ( x ) - \sum log ( - {f}_{k} ( x ) )$$

where the multiplication by t does not alter the optimisation problem.

As outlined in Table 1, the first and second derivatives (gradients and Hessians) of the composite cost function—and thus the original cost function and the logarithmic constraint functions—must be computed. These derivatives are given below.

$$Gradients \text{:}$$

$$∇ {f}_{0} ( x ) = ( {D}^{H} {W}^{H} WD + {( {D}^{H} {W}^{H} WD )}^{T} ) x$$

$$∇ {g}_{1} ( x ) = \frac{2}{t ( N - ɛ - {‖ x ‖}_{2}^{2} )} x$$

$$∇ {g}_{2} ( x ) = \frac{2}{t ( N + ɛ - {‖ x ‖}_{2}^{2} )} x$$

$$∇ {g}_{m + 2} ( x ) = - \frac{1}{t ( {e}_{m}^{T} x - δ )} {e}_{m}$$

$$Hessians \text{:}$$

$${∇}^{2} {f}_{0} ( x ) = {D}^{H} {W}^{H} WD + {( {D}^{H} {W}^{H} WD )}^{T}$$

$${∇}^{2} {g}_{1} ( x ) = \frac{2}{{t ( N - ɛ - {‖ x ‖}_{2}^{2} )}^{2}} ( 2 {xx}^{T} + ( N - ɛ - {‖ x ‖}_{2}^{2} ) I )$$

$${∇}^{2} {g}_{2} ( x ) = \frac{2}{{t ( N + ɛ - {‖ x ‖}_{2}^{2} )}^{2}} ( 2 {xx}^{T} + ( N + ɛ - {‖ x ‖}_{2}^{2} ) I )$$

$${∇}^{2} {g}_{m + 2} ( x ) = \frac{1}{{t ( {e}_{m}^{T} x - δ )}^{2}} {e}_{m} {e}_{m}^{T}$$

where I is the N×N identity matrix. Armed with these derivatives and given a strictly feasible starting vector x (i.e. a vector that satisfies the original constraints on the problem), the barrier method (as shown in Table 1) can be implemented to find an optimal vector x* that minimises the cost function described above subject to the aforementioned constraints.

As observed in Table 1 (supra), the barrier method relies on several parameters to perform optimisation. These parameters—specifically, μ, ε₀, εᵢ, and an initial value of t—are typically design parameters and can take on a range of values. Specific values that work well for most practical interference avoidance cases of interest (e.g. nulling 9 upsampled tones out of a total of 512 upsampled tones) have been found to be
μ=20
initial value of t=t⁽⁰⁾=(N+2)/∥WDx⁽⁰⁾∥₂²
   where x⁽⁰⁾ is the feasible starting vector.

Furthermore, it is beneficial to choose a parameter δ that provides sufficient flexibility for deep frequency notch creation while facilitating robust blind detection at the receiver. Obviously, as δ decreases, some data symbols may not be transmitted with much power, thus leading to a lower signal-to-noise ratio (SNR) for those symbols at the receiver. Consequently, the overall performance of the system suffers. This problem can be mitigated somewhat through the use of suitable forward error correcting codes such as powerful convolutional codes, turbo codes, or low-density parity check codes. However, there will always be a small degradation in performance due to the parameter δ.

In practice, a value of δ=1/\sqrt{2} only allows a reduction in transmit power for a given data symbol by ½. This reduction is sufficiently minor to allow the error correcting code that is employed to mitigate the negative effects on SNR. However, the depth of the frequency notch may suffer if the notch is on the order of several upsampled tones wide. A value of δ=½, while causing greater reductions in SNR, provides sufficient flexibility to the optimisation algorithm to achieve frequency notches on the order of −30 to −60 dB in depth for a width of several upsampled tones. The performance of a system with this value of 8 is not significantly degraded as shown in FIG. 9. Indeed, as shown in this example, the performance loss relative to a reference system where interference avoidance is not implemented (or needed) is only 1-2 dB, whereas the degradation in performance for a single-carrier system using AIC is much greater.

It should be noted that the reduction in SNR caused by δ is localised to individual data symbols. Indeed, the average SNR remains the same as for an unconstrained system due to the power constraint that is employed. Due to this constraint, some data symbols may actually benefit from an increase in SNR so that the total average power in a transmitted block is normalised.

Of course, a feasible starting vector x⁽⁰⁾ needs to be chosen. A very simple starting vector x⁽⁰⁾ that satisfies the constraints is simply a length-N vector of ones. Other starting vectors do not seems to affect the performance or rate-of-convergence of the algorithm.

The line search for finding β (see Table 1) is part of the standard barrier method as discussed in Boyd et al. (supra). Examples of this technique include the ‘exact’ line search and the ‘backtracking’ line search. However, any standard line search can be used to obtain the scaling value β.

If desired, the algorithm may optionally be sped up. To this end, a ‘minimum notch depth’ can be defined to aid the execution time of the interference avoidance algorithm when it is implemented numerically (e.g. using the barrier method). In this case, a ‘null depth condition’ (NDC) is checked with each update of the vector x. If the NDC is satisfied (i.e. max |[WDx]ₘ|²≦η where η is the desired null depth), the algorithm exits and the current x is taken to be the ‘optimal’ x. Empirical studies have shown that this technique can reduce the computation time by one half.

Moreover, a ‘fail mode’ can be implemented to ensure that signals without sufficient nulls are not transmitted. For example, a fail mode may be triggered after a predetermined number of iterations of the numerical optimisation algorithm if convergence to an optimal x has not been achieved. Also, a fail mode may be triggered if an NDC is not satisfied. (This is applicable to analytical and numerical implementations of cost/utility function minimisation/maximisation.) In the event that a fail mode is triggered for an interference avoidance algorithm, the transmitter can apply any number of additional measures to ensure the energy transmitted on the ‘interference tones’ does not exceed a predetermined threshold:

1. TPC can be implemented for the block that has failed;

2. AIC can be implemented for the block that has failed;

3. Frequency notching can be implemented through other means as well for the block that has failed;

4. The transmitter can reorder or puncture some of the symbols in the transmitted block in a pseudorandom manner known to the receiver and recompute the vector x in the hope that a fail mode is not triggered for this new block;

5. The transmitter can refrain from transmitting the offending block.

The qualitative application of the barrier method to dynamically optimise a block of data for interference avoidance is as follows:

1) The constraints of the problem are chosen.

2) The parameters t⁽⁰⁾, μ and tolerances of the algorithm ε₀, εᵢ are chosen.

3) A starting vector x that satisfies the constraints is chosen (e.g. the vector of ones).

4) Newton's method is run.

5) With each iteration of Newton's method, an NDC is checked.
a. If the NDC is not met, skip to step c)
b. If the NDC is met, the current vector x is taken to be optimal and the algorithm exits.
c. If the inner tolerance εᵢ is met (cf. Table 1), the current optimal vector x is the output of Newton's method (go to step 6)).
d. If the inner tolerance is not met, go to step 5).

6) Check outer tolerance.
a. If outer tolerance ε₀ is met or the NDC is met, quit iterations and current optimal vector is the final optimal vector.
b. Else if a fail mode is triggered, implement one of the fail mode options described above.
c. Else, increase t and go to step 4) where starting vector is current optimal vector.

It will be understood that the envelope function is not limited to being applied to all data symbols in a block. Indeed, any subset of data symbols can be perturbed by the envelope function. By reducing the number of affected symbols, the SNR degradation (or amplification) is limited to only those symbols, which can improve performance. Since fewer degrees of freedom are allocated to the optimisation algorithm in this case, this approach should only be used when the width of the desired notch is relatively small (on the order of a few upsampled tones).

If desired, an alternative barrier method formulation may be applied. The problem formulation for interference avoidance detailed above relies on the relaxation of the power constraint to a box inequality constraint in order to utilise the barrier method. An alternative method of eliminating the nonlinear equality constraint is to parameterise the length-N vector x as a function of a length-(N−1) vector z (i.e. x=h(z)). The vector z is simply a vector of N−1 angles that can be used to define a point on an N-dimensional hypersphere. This approach results from the observation that the constraint

∥x∥₂²=N

simply defines the vector x as a point on an N-dimensional ball or hypersphere. Specifically, the vector z is given by z=(z₁, . . . ,z_{N-1})^{T} and the vector h(z) is defined as

$$h ( z ) = \sqrt{N} ( \begin{matrix}cos ( {z}_{1} ) \\ sin ( {z}_{1} ) cos ( {z}_{2} ) \\ ⋮ \\ sin ( {z}_{1} ) … sin ( {z}_{N - 2} ) cos ( {z}_{N - 1} ) \\ sin ( {z}_{1} ) … sin ( {z}_{N - 2} ) sin ( {z}_{N - 1} )\end{matrix} ) .$$

Replacing x with this expression in the problem formulation given above, the equality constraint can be eliminated and the barrier method can be used to solve the optimisation problem.

The advantages of the above are, among others, that additional constraints can be added to the optimisation problem to aid practical systems. For example, a peak-to-average power ratio (PAPR) constraint can be placed on the transmitted signal so that the linearity requirements and/or back-off of the power amplifiers can be relaxed.

Furthermore, its tuneable nature (both in terms of notch depth and algorithmic complexity) allows this technique to be utilised by a broad range of wireless devices, including base stations and mobile terminals.

As described above, the present invention aims to overcome the drawbacks of the state of the art. The present invention aims to allow a broadband user to continue to transmit at full power without significantly affecting other (narrowband) users' transmissions. The proposed invention further aims to dynamically provide accurate frequency notching with a tuneable depth (on the order of −30 to −60 dB). Finally, as shown in FIG. 9, dynamically optimised interference cancellation in single-carrier systems with fixed transmission length does not incur a significant performance loss when the proposed invention is implemented.

No doubt many other effective alternatives will occur to the skilled person. It will be understood that the invention is not limited to the described embodiments and encompasses modifications apparent to those skilled in the art lying within the spirit and scope of the claims appended hereto.

1. A method of shaping the spectrum of a signal in a block transmission system by applying a time-domain envelope function comprising:
optimising the time-domain envelope function under one or more constraints selected from a set of predetermined constraints;
applying the optimised time-domain envelope function to the signal.

2. The method of claim 1 in which the optimised time-domain envelope function is applied in a dynamic manner.

3. The method of claim 1 in which the time-domain envelope function is optimised in a dynamic manner.

4. The method of claim 3 in which the dynamic optimisation is applied to each symbol transmission.

5. The method of claim 1 in which the set of constraints is chosen in order to establish interference avoidance, a cost function, or a utility function.

6. The method of claim 1 in which the signal transmission system is a single-carrier, a multi-carrier, or an OFDM block transmission system.

7. The method of claim 1 in which the envelope function is applied to all time-domain samples in a data block.

8. The method of claim 1 in which the envelope function is applied to all time-domain samples in a subset of a data block.

9. The method of claim 1 in which the criterion selected is interference avoidance.

10. The method of claim 1 in which the predetermined constraints comprise signal transmission characteristics, selected from among the group comprising PAPR, total power, and dynamic range.

11. The method of claim 1 in which the dynamic optimisation of the envelope function is performed numerically in an iterative manner.

12. The method of claim 11 wherein the numerical optimisation technique is selected from the group comprising a gradient method, a steepest descent method, Newton's method, the barrier method, or the primal-dual method.

13. The method of claim 11 wherein the envelope function is constrained to be real-valued and positive so as to facilitate blind detection at the receiver.

14. The method of claim 11 wherein the constellation of the data signal is constrained to be constant modulus so as to facilitate blind detection at the receiver.

15. The method of claim 11 wherein the parameters of the numerical optimisation technique, such as the stopping criteria, can be tuned.

16. A computer program comprising data processing device program code means adapted to perform the method of any of claims 1 to 15 when said program is run on a data processing device.

17. A computer-readable medium comprising computer-executable instructions to configure a signal transmission system to operate in accordance with any one of claim 1 to 15.

18. A spectrum-shaped signal generated by the method according to any one of claim 1 to 15.

19. A signal transmission system comprising means for operating in accordance with any one of claims 1 to 15.

20. A receiver comprising means for receiving a spectrum-shaped signal in accordance with any of claims 1 to 15.
